(19) United States
(12) Patent Application Publication
(10) Pub. No.: US 2014/0318509 A1
(43) Pub. Date: Oct. 30, 2014

(54) PRE-HEATER SYSTEM FOR A COMBUSTION ENGINE

(71) Applicant: Fernand St-Onge, Plantagenet Nord (CA)

(72) Inventor: Fernand St-Onge, Plantagenet Nord (CA)

(21) Appl. No.: 14/260,495

(22) Filed: Apr. 24, 2014

(30) Foreign Application Priority Data
Apr. 26, 2013 (GB) 1307549.4

(51) Int. Cl. F02M 31/02

(52) U.S. Cl. CPC F02M 31/02
USPC 123/557

(57) ABSTRACT

A pre-heater system for a combustion engine. The combustion engine uses a liquid fuel and air, and is cooled by a cooling system. The pre-heater system includes a fuel pre-heater. The fuel pre-heater includes a coolant reservoir and a fuel line traversing the coolant reservoir. The coolant reservoir is in a fluid relationship with the cooling system, and the fuel line is in a fluid relationship between a fuel tank and the combustion engine. In some embodiments, the pre-heater system further includes an air pre-heater. The air pre-heater comprises an air box and a coolant line traversing the air box. The air box is in a fluid relationship between the ambient air and the combustion engine, and the coolant line is in a fluid relationship with the cooling system. In operation, the fuel and air is heated before being consumed by the combustion engine.

### FIELD OF THE INVENTION

The present invention relates generally to pre-heater systems and, more particularly, to a pre-heater system for a combustion engine using a liquid fuel and air.

### BACKGROUND OF THE INVENTION

Pre-heater systems for combustion engines using a liquid fuel and air are known. These known pre-heater systems generally aim at raising the fuel economy of the engine by at least slightly heating the liquid fuel and intake air prior to their combustion in the engine.

Such systems generally include some form of heat exchanger for raising the temperature of the liquid fuel and/or intake air of the engine prior to entering the engine.

Thus, the pre-heater systems generally improve the efficiency of the combustion process in the engine particularly in cold weather conditions where the initial temperatures of the liquid fuel and air are not at the manufacturer's specified values for an optimum operation of the engine.

Typical examples of known pre-heater systems for a combustion engine are U.S. Pat. No. 5,819,712, to Cox (Oct. 13, 1998), U.S. Pat. No. 4,754,742, to Young (Jul. 5, 1988), U.S. Pat. No. 4,404,948, to Feltrin (Sep. 20, 1983), U.S. Pat. No. 4,341,194, to Wolters et Al. (Jul. 27, 1982), U.S. Pat. No. 4,326,491, to Burchett (Apr. 27, 1982), U.S. Pat. No. 4,319,554, to Buffie (Mar. 16, 1982), and U.S. Pat. No. 4,146,002, to Quinn (Mar. 27, 1979).

While the systems described in these documents can generally fulfill the main objective of raising the temperature of the liquid fuel and/or intake air prior to entering the engine, they are most likely inefficient in achieving the presumed fuel economies indicated in these same documents.

For example, the components and their structural configurations used in the assembly of these pre-heaters systems stem from either a poor design that inadequately transfers heat from the coolant fluid of the engine to the liquid fuel and/or intake air of the engine, or are not adapted to the new structures of the more recent brands and makes of cars. For example, these pre-heater systems do not generally take into account the limited space available or the new air intake duct and filter configurations of the newer compact and sub-compact vehicles actually on the market.

These known pre-heater systems are also generally relatively complex and costly to manufacture.

Against this background, there exists a need for an improved pre-heater system for a combustion engine using a liquid fuel and air. An object of the present invention is to provide such a system.

### SUMMARY OF THE INVENTION

In a broad aspect, the present invention provides a pre-heater system for a combustion engine using a liquid fuel and air.

The combustion engine is in a fluid communication relationship with a fuel tank for receiving the fuel therefrom. Furthermore, the combustion engine is cooled by a cooling system in which a liquid coolant circulates.

The pre-heater system comprises a fuel pre-heater. The fuel pre-heater includes a coolant reservoir and a fuel line traversing the coolant reservoir. The fuel line is insertable between the fuel tank and the combustion engine. The coolant reservoir defines reservoir input and output ports both in a fluid communication relationship with the coolant reservoir.

The reservoir input and output ports are both connectable in a fluid communication relationship with the cooling system for respectively receiving the coolant therefrom and releasing the coolant thereto.

Furthermore, the fuel line defines fuel input and output ports. The fuel input and output ports and are connectable respectively in a fluid communication relationship with the fuel tank and the combustion engine for respectively receiving the fuel therefrom and releasing the fuel thereto.

Thus, in operation, the fuel circulates through the fuel line before being delivered to the combustion engine and the coolant circulates through the coolant reservoir to heat the fuel.

In some embodiments, the fuel line follows a serpentine path through the coolant reservoir. In other embodiments, the fuel line follows a substantially Z-shaped path through the coolant reservoir.

In some embodiments, the fuel line defines at least two fuel line main sections in the coolant reservoir, the at least two fuel line main sections each following a serpentine path in a respective main section plane, the main section planes being in a substantially spaced apart and parallel relationship relative to each other, the fuel line also defining fuel line connecting sections extending between the fuel line main sections.

In some embodiments, the fuel line includes a pair of substantially planar plenums and at least one connecting tube extending therebetween, the plenums being substantially parallel to each other and provided each substantially adjacent a respective one of the reservoir input and output ports, the plenums being each in a fluid communication relationship with a respective one of the fuel input and output ports.

In some embodiments, the system further includes an air pre-heater, the air pre-heater including an air box containing an air filter, the air box defining air box input and output ports both in a fluid communication relationship with the air box for respectively receiving the air from ambient air and releasing the air towards the combustion engine; and a coolant line following a serpentine path along the air filter, the coolant line defining coolant line input and output ports both connectable in a fluid communication relationship with the cooling system for respectively receiving the coolant therefrom and releasing the coolant thereto.

In some embodiments, the air filter and the coolant line are substantially adjacent to each other. For example the air filter and the coolant line are substantially parallel to each other.

In some embodiments, the air pre-heater further includes a control valve in fluid communication with the coolant line for controlling a flow rate of the coolant through the coolant line.

In some embodiments, the system further comprises a thermostat-valve selectively obstructing one of the reservoir input and output ports, the thermostat-valve being operable between an open configuration allowing circulation of the coolant therethrough and a closed configuration preventing circulation of the coolant therethrough, the thermostat-valve being in the open configuration when the coolant in the coolant reservoir is substantially below a predetermined temperature and the thermostat-valve being in the closed configuration when the coolant in the coolant reservoir is substantially above the predetermined temperature. For example, the predetermined temperature is between about 30° C. and about 37° C.

In some embodiments, the system further comprises a pressure release valve in a fluid communication relationship with the fuel line and connectable in a fluid communication relationship with the fuel tank, the pressure release valve preventing passage of the fuel therethrough when a fuel pressure in the fuel line is substantially below a predetermined pressure, the pressure release valve allowing passage of the fuel therethrough when the fuel pressure in the fuel line is substantially above the predetermined pressure.

In some embodiments, the coolant reservoir defines substantially opposite reservoir sides, the reservoir input and output ports being provided in different ones of the reservoir sides.

In some embodiments, the fuel pre-heater further includes at least one baffle provided in the coolant reservoir between the reservoir input and output ports, the at least one baffle being configured and sized for preventing direct rectilinear flow of the coolant in the reservoir between the reservoir input and output ports so that the coolant follows a curved path through the coolant reservoir.

In another broad aspect, the invention provides a pre-heater system for a combustion engine using a liquid fuel and air, the combustion engine being in a fluid communication relationship with a fuel tank for receiving the fuel therefrom, the combustion engine being cooled by a cooling system in which a coolant circulates, the cooling system including a coolant tube in which the coolant circulates, the system comprising: a fuel pre-heater, the fuel pre-heater including a fuel line, the fuel line defining fuel input and output ports, the fuel input and output ports being connectable respectively in a fluid communication relationship with the fuel tank and the combustion engine for respectively receiving the fuel therefrom and releasing the fuel thereto. When the fuel pre-heater is installed in an operational configuration, the fuel line and the coolant tube are in a thermal exchange relationship with each other. In operation, the fuel circulates through the fuel line before being delivered to the combustion engine so that the coolant circulating in the coolant tube heats the fuel when the coolant is warmer than the fuel.

In some embodiments, when the fuel pre-heater is installed in the operational configuration, the fuel line and the coolant line are in contact with each other.

In some embodiments, the fuel line has a substantially serpentine configuration.

In yet another broad aspect, the invention provides a propulsion system for a motor vehicle using a liquid fuel and air, the propulsion system also using a liquid coolant, the propulsion system comprising; a fuel tank for containing the fuel; a combustion engine in a fluid communication relationship with the fuel tank for receiving the fuel therefrom; a cooling system in which the coolant circulates, the cooling system being in a thermal exchange relationship with the combustion engine; and a pre-heater system, the pre-heater system including: a fuel pre-heater, the fuel pre-heater including a coolant reservoir and a fuel line traversing the coolant reservoir, the fuel line being insertable between the fuel tank and the combustion engine; the coolant reservoir defining reservoir input and output ports both in a fluid communication relationship with the coolant reservoir, the reservoir input and output ports being both in a fluid communication relationship with the cooling system for respectively receiving the coolant therefrom and releasing the coolant thereto; the fuel line defining fuel input and output ports, the fuel input and output ports being respectively in a fluid communication relationship with the fuel tank and the combustion engine for respectively receiving the fuel therefrom and releasing the fuel thereto. In operation, the fuel circulates through the fuel line before being delivered to the combustion engine and the coolant circulates through the coolant reservoir to heat the fuel.

Advantageously, in some embodiments, the proposed pre-heater system has a configuration that provides an appropriate heat transfer to the fuel, the air, or both the fuel and air to bring a fuel air mixture at a suitable temperature prior to entering the engine.

Also, in some embodiments, the proposed system is relatively easily retrofittable a car, truck or other motor vehicle.

Other advantages, novel features and alternate embodiments of the present invention will be more apparent from the following drawings and detailed description.

### BRIEF DESCRIPTION OF THE DRAWINGS

FIG. 1, in schematic view, illustrates a pre-heater system according to an embodiment of the present invention, here shown installed on a liquid cooled combustion engine and including a fuel pre-heater and an air pre-heater;

FIG. 2, in a see-through, perspective view, illustrates an embodiment of the fuel pre-heater of FIG. 1, here shown including a coolant reservoir drawn in stippled lines;

FIG. 3, in a side elevational view, illustrates the fuel pre-heater of FIG. 2;

FIG. 4, in a top plan view, illustrates the fuel pre-heater of FIG. 2;

FIG. 5, in a see-through, perspective view, illustrates another embodiment of a fuel pre-heater usable to replace the fuel pre-heater of FIG. 1, here shown including a coolant reservoir drawn in stippled lines;

FIG. 6, in a top plan view, illustrates the fuel pre-heater of FIG. 5;

FIG. 7, in a bottom plan view, illustrates the fuel pre-heater of FIG. 5;

FIG. 8, in a side elevational view, illustrates the fuel pre-heater of FIG. 5;

FIG. 9, in a front elevational view, illustrates the fuel pre-heater of FIG.

5;

FIG. 10, in a perspective view, illustrates another embodiment of a fuel pre-heater, here shown engaged on a coolant fluid tube;

FIG. 11, in a front elevational view, illustrates the fuel pre-heater of FIG. 10;

FIG. 12, in schematic view, illustrates a pre-heater system according to another embodiment of the present invention, here shown installed on a liquid cooled combustion engine and including the fuel pre-heater illustrated in FIGS. 5 to 8 inclusively; and

FIG. 13, in schematic view, illustrates a pre-heater system according to yet another embodiment of the present invention, here shown installed on a liquid cooled combustion engine and including the fuel pre-heater illustrated in FIGS. 10 and 11.

### DETAILED DESCRIPTION OF THE INVENTION

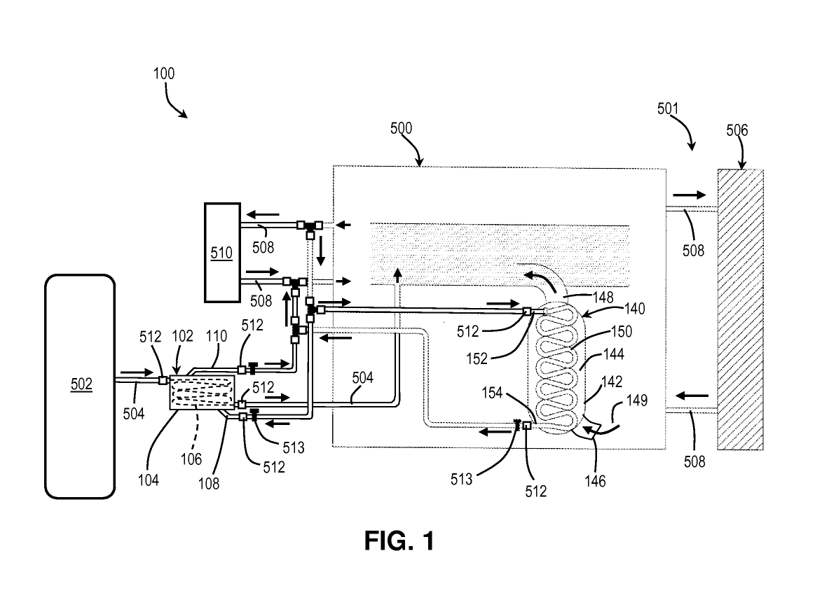

FIG. 1 illustrates a pre-heater system 100 for a combustion engine 500 using a liquid fuel and air, according to an embodiment the present invention. The combustion engine 500 is in a fluid communication relationship with a fuel tank 502 for receiving the fuel therefrom. Typically, the combustion engine 500 is in a fluid communication relationship with a fuel tank 502 through fuel tubes 504 extending therebetween.

Furthermore, the combustion engine 500 is cooled by a cooling system 501 in which a liquid coolant circulates. Typically, the cooling system 501 includes an engine radiator 506 in fluid communication relationship with the combustion engine 500 through send and return coolant tubes 508. Typically, the combustion engine 500 is further in fluid communication relationship with a cab interior radiator 510, also through send and return coolant tubes 508.

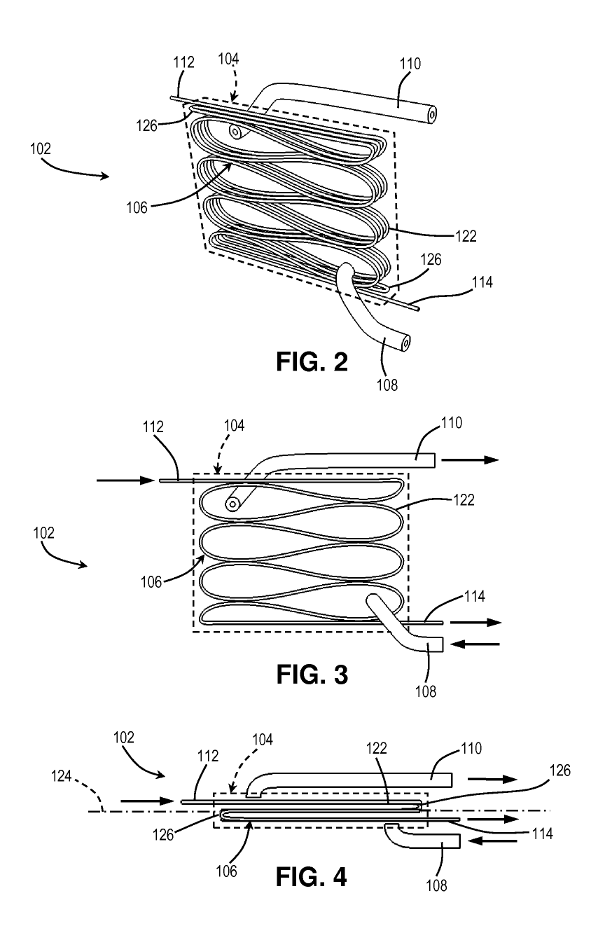

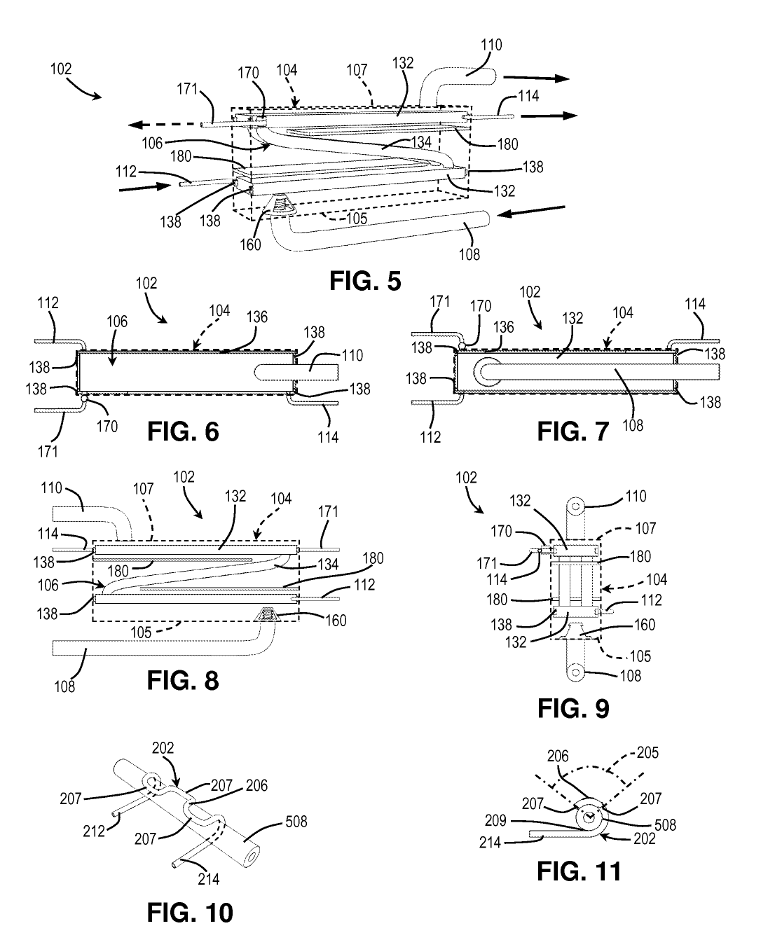

With reference to FIGS. 1 to 4 inclusively, the pre-heater system 100 comprises a fuel pre-heater 102. The fuel pre-heater 102 includes a coolant reservoir 104 and a fuel line 106 traversing the coolant reservoir 104. The fuel line 106 is insertable between the fuel tank 502 and the combustion engine 500, as illustrated in FIG. 1. In some embodiments of the invention, as best illustrated in FIGS. 2 and 3, the fuel line 106 follows a serpentine path through the coolant reservoir 104. In other embodiments, as best illustrated in FIGS. 5 and 8, the fuel line 106 follows a substantially Z-shaped path through the coolant reservoir 104.

The coolant reservoir 104 defines reservoir input and output ports 108 and 110 both in a fluid communication relationship with the coolant reservoir 104. The reservoir input and output ports 108 and 110 are both connectable in a fluid communication relationship with the cooling system 501 for respectively receiving the coolant therefrom and releasing the coolant thereto.

Furthermore, the fuel line 106 defines fuel input and output ports 112 and 114 (not shown in FIG. 1). The fuel input and output ports 112 and 114 are connectable respectively in a fluid communication relationship with the fuel tank 502 and the combustion engine 500 for respectively receiving the fuel therefrom and releasing the fuel thereto.

Advantageously, in some embodiments, the reservoir input and output ports 108 and 110, and fuel input and output ports 112 and 114 respectively, may be fluidly coupled with the fuel tank 502, the combustion engine 500 and the cooling system 501 using suitable coolant tubes 508 and fuel tubes 504 respectively, through suitable couplings connectors 512, as illustrated in FIG. 1.

Furthermore, as illustrated for example in FIG. 1, the reservoir input and output ports 108 and 110 may be advantageously fluidly coupled with a coolant fluid output port of the combustion engine 500 and a coolant fluid input port of the cab interior radiator 510 respectively. Other choices of a coolant tubes 508 within the cooling system 501 are also possible.

Thus, in operation, the fuel circulates through the fuel line 106 before being delivered to the combustion engine 500 and the coolant circulates through the coolant reservoir 104 to heat the fuel.

With reference to FIGS. 2, 3 and 4, in some embodiments, the fuel line 106 defines at least two fuel line main sections 122 in the coolant reservoir 104. The at least two fuel line main sections 122 each following a serpentine path in a respective main section plane 124 (better seen in FIG. 4). The main section planes 124 are in a substantially spaced apart and parallel relationship relative to each other. The fuel line 106 also defines fuel line connecting sections 126 extending between the fuel line main sections 122. This configuration allows packing a relatively compactly relatively long fuel lines 106.

With reference to FIGS. 5 to 9 inclusively, in some other embodiments, the fuel line 106 includes a pair of substantially planar plenums 132 and at least one connecting tube 134 extending therebetween. The plenums 132 are substantially parallel to each other and provided each substantially adjacent a respective one of the reservoir input and output ports 108 and 110. The plenums 132 are each in a fluid communication relationship with a respective one of the fuel input and output ports 112 and 114.

As illustrated in FIGS. 5 to 9 inclusively, each plenum 132 may have a substantially elongated and rectangularly shaped box configuration having outer dimensions at least slightly smaller than the inner surface dimensions of the coolant reservoir 104 so as to leave a predetermined peripheral space 136 between the plenums 132 and adjacent wall portions of the coolant reservoir 104. For example, the predetermined peripheral space 136 may be roughly ⅛ of an inch wide. Other values for the predetermined peripheral space 136 are also possible.

The plenums 132 may be held in place relative to the coolant reservoir 104 through, for example, suitably spaced apart intermediate members 138. Thus, coolant fluid may circulate substantially all around the plenums 132 through the predetermined peripheral space 136 for maximizing a thermal exchange between the coolant fluid and the fuel circulating through the plenums 132.

In some embodiments, the pre-heater system 100 further comprises an air pre-heater 140, as illustrated, for example, in FIG. 1. The air pre-heater 140 includes an air box 142 containing an air filter 144. The air box 142 defines air box input and output ports 146 and 148 both in a fluid communication relationship with the air box 142 for respectively receiving the air from ambient air 149 and releasing the air towards the combustion engine 500. The air box 142 and air filter 144 may be conventional components part of a car to which the air pre-heater 140 is fitted.

The air pre-heater 140 further includes a coolant line 150 following a serpentine path along the air filter 144. The coolant line 150 defining coolant line input and output ports 152 and 154 both connectable in a fluid communication relationship with the cooling system 501 of the combustion engine 500 for respectively receiving the coolant therefrom and releasing the coolant thereto. As in the fuel pre-heater 102, the coolant line input and output ports 152 and 154 may be advantageously connectable to the cooling system 501 through suitable couplings connectors 512.

Typically, the air filter 144 and the coolant line 150 are substantially adjacent to each other. Also typically, the air filter 144 and the coolant line 150 are substantially parallel to each other.

In some embodiments, a control valve 513 may be my fluidly coupled between one of the coolant line input and output ports 152 and 154, and the cooling system 501, or be in any other suitable manner in fluid communication with the coolant line 150, for allowing a manual adjustment of the flow rate of coolant liquid circulating in the coolant line 150.

Furthermore, as it would be familiar to mechanic personnel doing routine maintenance on fuel injection vehicles, the factory engine air filter unit is generally represented by a substantially square or rectangular shaped two-part air box, 142 as opposed to relatively older annular shaped configurations of air box attached on top of carburetor equipped combustion engines. When a top part, or cover of the box shaped air box 142 is removed, a substantially flat portion of the intake side of a removable air filter 144 is exposed. It is on this substantially flat portion of the removable air filter 144 that the serpentine shaped coolant line 150 may rest flatly parallelly there against, with the coolant line input and output ports 152 and 154 extending through wall portions of the air box 142. Thus, as would be obvious to someone versed in the art of aftermarket automotive parts, a factory made air box 142 including an air filter 144 may be readily and economically retrofitted into an air pre-heater 140 of the present invention.

In some embodiments, as exemplified in FIGS. 5, 8 and 9, the pre-heater system 100 further comprises a thermostat-valve 160 for selectively obstructing one of the reservoir input and output ports 108 and 110. The thermostat-valve 160 is operable between an open configuration allowing circulation of the coolant therethrough and a closed configuration preventing circulation of the coolant therethrough. The thermostat-valve 160 is in the closed configuration when the coolant in the coolant reservoir 104 is substantially above a predetermined temperature and the thermostat-valve 160 is in the open configuration when the coolant in the coolant reservoir 104 is substantially below the predetermined temperature. Typically, the predetermined temperature is between about 30° C. and about 37° C., for example about 33° C.

As would be obvious to someone familiar with common combustion engine thermostat valves of the automotive industry, the thermostat-valve 160 in the present invention has an inverted operation relative to its predetermined temperature. Such thermostat-valve having an inverted operation is readily commercially available through specialized valve retailers.

Furthermore, as would be obvious to someone familiar with common combustion engine thermostat valves of the automotive industry, a hysteresis behavior is also observed in the operation of the thermostat valve 160 of the present invention. Accordingly, the temperature of the coolant fluid in contact with the thermostat-valve 160 may substantially increase above the predetermined temperature before the thermostat valve actually closes and, inversely, the temperature of the coolant fluid in contact with the thermostat valve 160 may substantially decrease below the predetermined temperature before the thermostat valve actually opens.

Furthermore, as is also well known with thermostats valves of the automotive industry in general, the thermostat-valve 160 operate between the open and close configuration in a substantially gradual manner so as to substantially smoothly regulate the temperature of the coolant fluid circulating through a combustion engine to substantially near the predetermined temperature, when taking into account the hysteresis behavior described above.

As illustrated, for example in FIG. 1, alternatively or concurrently with the thermostat-valve 160, a control valve 513 may be my fluidly coupled between one or both the reservoir input and output ports 108 and 110, and the combustion engine 500, for allowing a manual adjustment of the flow of coolant liquid circulating through the coolant reservoir 104.

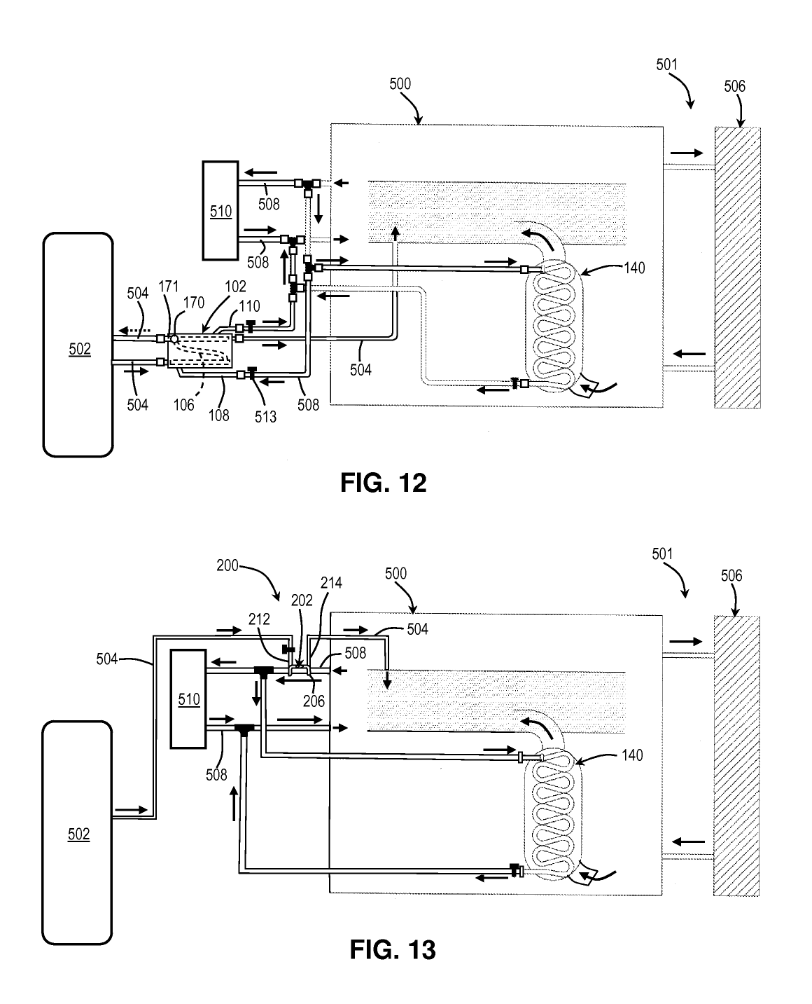

In some embodiments, as exemplified in FIGS. 5, 8, 9 and 12 respectively, the pre-heater system 100 further comprises a pressure release valve 170 in a fluid communication relationship with the fuel line 106 and connectable in a fluid communication relationship with the fuel tank 502 through typically a pressure release valve output port 171 and a fuel tube 504. The pressure release valve 170 is for preventing passage of the fuel therethrough when a fuel pressure in the fuel line 106 is substantially below a predetermined pressure. Furthermore, the pressure release valve 170 allows passage of the fuel therethrough when the fuel pressure in the fuel line 106 is substantially above the predetermined pressure. The predetermined pressure at which the pressure release valve 170 operates is dependent on a factory set engine fuel pressure value for an optimum efficiency of the combustion engine 500.

Thus, with the pressure release valve 170 in a fluid communication relationship with the fuel tank 502, when the predetermined pressure in the fuel line 106 is exceeded, the exceeding liquid fuel volume circulating therein, due to its heat expansion, is returned back to the fuel tank 502 until the fuel pressure in the fuel line 106 decreases below the predetermined pressure.

In some embodiments, the coolant reservoir 104 defines substantially opposite reservoir sides and the reservoir input and output ports 108 and 110 are respectively provided in different ones of the reservoir sides. As exemplified in FIGS. 5 and 8, the opposite reservoir sides may be defined by a reservoir bottom side 105 and an oppositely facing reservoir top side 107, wherein the reservoir input port 108 is provided along a portion of the reservoir bottom side 105, and the reservoir output port 110 is provided along a portion of the reservoir top side 107 respectively.

Thus, when the combustion engine 500 has just been started and is running in substantially cold weather conditions, the relatively small quantity of thermal heat contained in the coolant fluid released in the coolant reservoir 104 through the reservoir input port 108 naturally raises by convection substantially upwardly within the coolant reservoir 104 toward the reservoir top side 107, and substantially accumulates therealong until it is exhausted by forced fluid circulation of the cooling system 501 through the reservoir output port 110. Hence, a substantially optimized volume of heated coolant fluid circulates along, and get in contact with, the fuel line 106 which, in turn, efficiently heats up the fuel circulating therein.

In some embodiments, as exemplified in FIGS. 5, 8 and 9 respectively, the pre-heater system 100 further includes at least one baffle 180 provided in the coolant reservoir 104 between the reservoir input and output ports 108 and 110 respectively. The at least one baffle 180 is configured and sized for preventing direct rectilinear flow of the coolant in the coolant reservoir 104 between the reservoir input and output ports 108 and 110 so that the coolant follows a curved path through the coolant reservoir 104.

For example, two baffles 180 may be suitably sized and shaped to extend substantially parallelly relative to a corresponding one of the plenums 132, and substantially oppositely relative to the corresponding one of the reservoir input and output ports 108 and 110, so as to allow the coolant fluid to circulate substantially longitudinally adjacently along a substantial portion of the side surfaces of the plenum 132. Thus, a significant thermal exchange occurs between the coolant fluid circulating in the coolant reservoir 104 and the fuel circulating in the corresponding plenum 132.

In accordance with an alternate embodiment of the present invention, FIG. 13 illustrates a pre-heater system 200 for a combustion engine 500 using a liquid fuel and air. Likewise in the embodiments of a pre-heater system 100 described further above, in the presently described embodiment, the combustion engine 500 is in a fluid communication relationship with a fuel tank 502 for receiving the fuel therefrom.

The combustion engine 500 is cooled by a cooling system 501 in which a coolant circulates. The cooling system 501 includes coolant tube 508 in which the coolant circulates. The pre-heater system 200 comprises a fuel pre-heater 202.

Now referring to FIGS. 10 and 11, the fuel pre-heater 202 includes a fuel line 206. The fuel line 206 defines fuel input and output ports 212 and 214. Returning to FIG. 13, the fuel input and output ports 212 and 214 are connectable respectively in a fluid communication relationship with the fuel tank 502 and the combustion engine 500 for respectively receiving the fuel therefrom and releasing the fuel thereto. When the fuel pre-heater 202 is installed in an operational configuration, the fuel line 206 and the coolant tube 508 are in a thermal exchange relationship with each other.

In operation, the fuel circulates through the fuel line 206 before being delivered to the combustion engine 500 so that the coolant circulating in the coolant tube 508 heats the fuel when the coolant is warmer than the fuel. Typically, when the fuel pre-heater 202 is installed in the operational configuration, the fuel line 206 and the coolant tube 508 are in contact with each other.

Also, typically, the fuel line 206 has a substantially serpentine configuration. For example, as exemplified in FIG. 10, the fuel line 206 may define a serpentine path extending substantially longitudinally, with lateral back and forth U-shaped loop portions 207 extending substantially circumferentially, relative to the typically cylindrically shaped surface of the coolant tube 508.

With reference to FIG. 11, the U-shaped loop portions 207 may extend circumferentially around the coolant tube 508 a predetermined radial angle 205 of about ninety (90) degree. Other values for the radial angle 205 are also possible. Furthermore, the fuel input and output ports 212 and 214 are extending tangentially to the coolant tube 508 in a spaced apart relationship along typically a same longitudinal surface portion of the coolant tube 508 that is substantially diametrically opposed relative to the tangentially extending fuel input and output ports 212 and 214.

Thus, a partially cylindrically shaped and longitudinally extending passageway 209 is defined substantially axially centrally within the fuel line 206. As best illustrated in FIG. 11, the partially cylindrically shaped passageway 209 may extend roughly between fifty five (55) and sixty five (65) percent (e.g. roughly between 200 and 235 degree) of the circumference of the coolant tube 508. Typically, the passageway 209 has an inner diameter that is slightly smaller than the outer diameter of the coolant tube 508. Typically, the diameter of the coolant tube 508 is one of the standard size rubber coolant tubes commonly found in the automotive industry.

Thus, with the fuel line 206 being typically made of a substantially rigid metal such as copper or the like, the latter may by resiliently engaged in a snap fit relation about a circumferential portion of the rubber made coolant tube 508 by introducing the latter laterally parallelly through the longitudinally extending opening formed along the serpentine configuration of the fuel line 206.

Furthermore, the number of back-and-forth U-shaped loop portions 207 of the fuel line 206 is dependent on the size of the combustion engine 500. For example, if the combustion engine 500 is the combustion engine of a sub-compact vehicle, only one U-shaped loop portion 207 may be required for heating the fuel circulating in the proportionally sized fuel line 206. Comparatively, if the combustion engine 500 is a large V8 engine in a large pickup truck or the like, for example, four (4) U-shaped loop portions 207, or more, may be required to sufficiently heat up the fuel circulating through the fuel line 206.

As exemplified in FIG. 13, and likewise the fuel pre-heater 102 described further above, the fuel line 206 may be resiliently engaged on a coolant tube 508 fluidly coupling a coolant fluid output port of the combustion engine 500 with a coolant fluid input port of the cab interior radiator 510. Other choices of coolant tubes 508 within the cooling system 501 are also possible.

Furthermore, the presently described embodiment of the pre-heater system 200 is advantageously usable in cooperative relation with a combustion engine 500 equipped with a direct fuel injection system. In such a direct fuel injection system, each fuel injector has its output jet integrated directly within a respective one of the combustion chambers of the engine, as opposed to a conventional fuel injection system wherein each fuel injector has its output jet integrated in a portion of the air intake manifold substantially adjacent the intake port of a respective one of the combustion chambers of the engine.

Furthermore, as is well known to someone familiar with fuel injection systems for automotive combustion engines, the direct fuel injection system generally requires a single fuel tubing connection between the fuel tank 502 and the combustion engine 500, as opposed to the typical dual send and overflow return fuel tubing's of the conventional fuel injection system (not shown in the drawings for sake of clarity).

Thus, the flow of fuel liquid circulating in the single fuel tube 504 of the direct injection system is relatively slower than in the send and overflow return tubes of the conventional fuel injection system since only the actually consumed fuel by the combustion engine 500 is required to circulate therein. Hence, only a few U-shaped loop portions 207 of the fuel line 106 are needed to be in contact with the coolant tube 508 for sufficiently raising the temperature of the fuel circulating in the fuel line 106.

Optionally, a control valve 513 may be my fluidly coupled between the fuel line 206, and the fuel tank 502, for allowing a manual adjustment of the flow of fuel liquid circulating therethrough.

Thus, a significantly more economical solution for a fuel pre-heater is provided with the fuel pre-heater 202 of the present invention, comparatively to known fuel pre-heater devices of the prior art since it only requires a suitably sized and configured fuel line 106 resiliently engaged on, and contacting with, an existing coolant tube 508 of the combustion engine 500.

In accordance with another alternate embodiment of the present invention, a propulsion system for a motor vehicle using a liquid fuel and air is described. The propulsion system also using a liquid coolant.

Likewise the embodiments of a pre-heater system 100 described further above, in the presently described embodiment, as illustrated, for example, in FIG.1, the propulsion system comprises a fuel tank 502 for containing the fuel, a combustion engine 500 in a fluid communication relationship with the fuel tank 502 for receiving the fuel therefrom, a cooling system 501 in which the coolant circulates, the cooling system 501 is in a thermal exchange relationship with the combustion engine 500, and a pre-heater system 100.

The pre-heater system 100 comprises a fuel pre-heater 102. The fuel pre-heater 102 includes a coolant reservoir 104 and a fuel line 106 traversing the coolant reservoir 104. The fuel line 106 is insertable between the fuel tank 502 and the combustion engine 500. The coolant reservoir 104 defines reservoir input and output ports 106 and 108 both in a fluid communication relationship with the coolant reservoir 104. The reservoir input and output ports 108 and 110 are both in a fluid communication relationship with the cooling system 501 for respectively receiving the coolant therefrom and releasing the coolant thereto.

Furthermore, the fuel line 106 defines fuel input and output ports 112 and 114. The fuel input and output ports 112 and 114 are respectively in a fluid communication relationship with the fuel tank 502 and the combustion engine 500 for respectively receiving the fuel therefrom and releasing the fuel thereto.

It is to be understood that the fuel pre-heater 102 may be represented by anyone one of the embodiments of a fuel pre-heater described further above.

Thus, in operation, the fuel circulates through the fuel line 106 before being delivered to the combustion engine 500 and the coolant circulates through the coolant reservoir 104 to heat the fuel.

It is to be noted that by heating the fuel before it is consumed in the combustion engine 500, the temperature of the latter is raised at a relatively higher temperature than the ambient temperature such that the liquid fuel is at least slightly expended in order to be better consumed within the engine.

Although the present invention has been described hereinabove by way of exemplary embodiments thereof, it will be readily appreciated that many modifications are possible in the exemplary embodiments without materially departing from the novel teachings and advantages of this invention. Accordingly, the scope of the claims should not be limited by the exemplary embodiments, but should be given the broadest interpretation consistent with the description as a whole. Since many embodiments of the invention can be practiced without departing from the spirit and scope of the invention, the invention resides in the claims hereinafter appended.

What is claim is:

1. A pre-heater system for a combustion engine using a liquid fuel and air, said combustion engine being in a fluid communication relationship with a fuel tank for receiving said fuel therefrom, said combustion engine being cooled by a cooling system in which a liquid coolant circulates, said system comprising:
a fuel pre-heater, said fuel pre-heater including a coolant reservoir and a fuel line traversing coolant reservoir, said fuel line being insertable between said fuel tank and said combustion engine;
said coolant reservoir defining reservoir input and output ports both in a fluid communication relationship with said coolant reservoir, said reservoir input and output ports being both connectable in a fluid communication relationship with said cooling system for respectively receiving said coolant therefrom and releasing said coolant thereto;
said fuel line defining fuel input and output ports, said fuel input and output ports being connectable respectively in a fluid communication relationship with said fuel tank and said combustion engine for respectively receiving said fuel therefrom and releasing said fuel thereto;
wherein, in operation, said fuel circulates through said fuel line before being delivered to said combustion engine and said coolant circulates through said coolant reservoir to heat said fuel.

2. A system as defined in claim 1, wherein said fuel line follows a serpentine path through said coolant reservoir.

3. A system as defined in claim 1, wherein said fuel line follows a substantially Z-shaped path through said coolant reservoir.

4. A system as defined in claim 1, wherein said fuel line defines at least two fuel line main sections in said coolant reservoir, said at least two fuel line main sections each following a serpentine path in a respective main section plane, said main section planes being in a substantially spaced apart and parallel relationship relative to each other, said fuel line also defining fuel line connecting sections extending between said fuel line main sections.

5. A system as defined in claim 1, wherein said fuel line includes a pair of substantially planar plenums and at least one connecting tube extending therebetween, said plenums being substantially parallel to each other and provided each substantially adjacent a respective one of said reservoir input and output ports, said plenums being each in a fluid communication relationship with a respective one of said fuel input and output ports.

6. A system as defined in claim 1, further comprising an air pre-heater, said air pre-heater including
an air box containing an air filter, said air box defining air box input and output ports both in a fluid communication relationship with said air box for respectively receiving said air from ambient air and releasing said air towards said combustion engine; and
a coolant line following a serpentine path along said air filter, said coolant line defining coolant line input and output ports both connectable in a fluid communication relationship with said cooling system for respectively receiving said coolant therefrom and releasing said coolant thereto.

7. A system as defined in claim 6, wherein said air filter and said coolant line are substantially adjacent to each other.

8. A system as defined in claim 6, wherein said air filter and said coolant line are substantially parallel to each other.

9. A system as defined in claim 6, wherein said air pre-heater further includes a control valve in fluid communication with said coolant line for controlling a flow rate of said coolant through said coolant line.

10. A system as defined in claim 1, further comprising a thermostat-valve selectively obstructing one of said reservoir input and output ports, said thermostat-valve being operable between an open configuration allowing circulation of said coolant therethrough and a closed configuration preventing circulation of said coolant therethrough, said thermostat-valve being in said open configuration when said coolant in said coolant reservoir is substantially below a predetermined temperature and said thermostat-valve being in said closed configuration when said coolant in said coolant reservoir is substantially above said predetermined temperature.

11. A system as defined in claim 10, wherein said predetermined temperature is between about 30° C. and about 37° C.

12. A system as defined in claim 1, further comprising a pressure release valve in a fluid communication relationship with said fuel line and connectable in a fluid communication relationship with said fuel tank, said pressure release valve preventing passage of said fuel therethrough when a fuel pressure in said fuel line is substantially below a predetermined pressure, said pressure release valve allowing passage of said fuel therethrough when said fuel pressure in said fuel line is substantially above said predetermined pressure.

13. A system as defined in claim 1, wherein said coolant reservoir defines substantially opposite reservoir sides, said reservoir input and output ports being provided in different ones of said reservoir sides.

14. A system as defined in claim 13, wherein said fuel pre-heater further includes at least one baffle provided in said coolant reservoir between said reservoir input and output ports, said at least one baffle being configured and sized for preventing direct rectilinear flow of said coolant in said reservoir between said reservoir input and output ports so that said coolant follows a curved path through said coolant reservoir.

15. A pre-heater system for a combustion engine using a liquid fuel and air, said combustion engine being in a fluid communication relationship with a fuel tank for receiving said fuel therefrom, said combustion engine being cooled by a cooling system in which a coolant circulates, said cooling system including a coolant tube in which said coolant circulates, said system comprising:
a fuel pre-heater, said fuel pre-heater including a fuel line, said fuel line defining fuel input and output ports, said fuel input and output ports being connectable respectively in a fluid communication relationship with said fuel tank and said combustion engine for respectively receiving said fuel therefrom and releasing said fuel thereto;
wherein, when said fuel pre-heater is installed in an operational configuration, said fuel line and said coolant tube are in a thermal exchange relationship with each other;
wherein, in operation, said fuel circulates through said fuel line before being delivered to said combustion engine so that said coolant circulating in said coolant tube heats said fuel when said coolant is warmer than said fuel.

16. A system as defined in claim 15, wherein, when said fuel pre-heater is installed in said operational configuration, said fuel line and said coolant line are in contact with each other.

17. A system as defined in claim 15, wherein said fuel line has a substantially serpentine configuration.

18. A propulsion system for a motor vehicle using a liquid fuel and air, said propulsion system also using a liquid coolant, said propulsion system comprising;
a fuel tank for containing said fuel;
a combustion engine in a fluid communication relationship with said fuel tank for receiving said fuel therefrom;
a cooling system in which said coolant circulates, said cooling system being in a thermal exchange relationship with said combustion engine; and
a pre-heater system, said pre-heater system comprising:
a fuel pre-heater, said fuel pre-heater including a coolant reservoir and a fuel line traversing said coolant reservoir, said fuel line being insertable between said fuel tank and said combustion engine;
said coolant reservoir defining reservoir input and output ports both in a fluid communication relationship with said coolant reservoir, said reservoir input and output ports being both in a fluid communication relationship with said cooling system for respectively receiving said coolant therefrom and releasing said coolant thereto;
said fuel line defining fuel input and output ports, said fuel input and output ports being respectively in a fluid communication relationship with said fuel tank and said combustion engine for respectively receiving said fuel therefrom and releasing said fuel thereto;
wherein, in operation, said fuel circulates through said fuel line before being delivered to said combustion engine and said coolant circulates through said coolant reservoir to heat said fuel.
